(19) United States
(12) Patent Application Publication
(10) Pub. No.: US 2006/0117383 A1
(43) Pub. Date: Jun. 1, 2006

(54) Smart cards, methods, and computer program products for using dummy currents to obscure data

(76) Inventors: Seung-Hyo Noh, Gyeonggi (KR); Jong-Cheol Kim, Gyeonggi-do (KR)

Correspondence Address: MYERS BIGEL SIBLEY & SAJOVEC, PO BOX 37428, RALEIGH, NC, 27627, US

(21) Appl. No.: 11/226,183

(22) Filed: Sep. 14, 2005

(30) Foreign Application Priority Data
Nov. 29, 2004 (KR) 2004-98671

(51) Int. Cl. H04L 9/32

(52) U.S. Cl. 726/20

(57) ABSTRACT

A smart card can include a circuit configured to conduct security operations on data maintained by the smart card and to generate currents indicative of the security operations. A current transforming circuit is coupled to the circuit and is configured to consume amounts of dummy currents based on the security operations.

### CROSS-REFERENCE TO RELATED APPLICATION

This U.S. non-provisional patent application claims priority under 35 U.S.C. § 119 of Korean Patent Application 2004-98671 filed on Nov. 29, 2004, the entire contents of which are hereby incorporated by reference.

### FIELD OF THE INVENTION

The present invention is concerned with smart cards, which in particular relates to security for smart cards.

### BACKGROUND

Integrated circuit cards are usually configured with each including a semiconductor device attached on a plastic card thereof as much as a credit card. Integrated circuit cards have been considered for use as multimedia information apparatuses as they may provide better data retention than conventional magnetic cards, and may provide better security. Some integrated circuit cards may be classified as smart cards with embedded microprocessors, and “contactless” memory cards that do not include microprocessors. Smart cards may have the advantage of high security and large data storage capacity, which may be suitable for a wide range of applications. Accordingly, smart cards have been used in applications in fields, such as finance, distribution, traffic, mobile communication, and so forth.

It is known that a smart card should store data securely. If the data stored in the smart card is not secure, it may be undesirable for a user or a system operator to store private or secret information in a smart card. The word “tempering” means an unauthorized access to a smart card. Techniques of tempering include invasive attacks using microprobes and non-invasive attacks using software tools. Non-invasive attacks can perform a side channel analysis that decrypts a key code of a cryptographic algorithm (e.g., DES algorithm) utilizing a pattern of power consumption (or current dissipation) or timing differences due to an operation of the smart card. The side channel analysis techniques can be classified as simple power analysis (SPA) and differential power analysis (DPA). The SPA is used to abstract a key code by way of analyzing a power itself calibrated during an execution of a cryptographic algorithm. Otherwise, the DPA is used to abstract a key code, applying the schemes of statistic and error correction with the SPA.

### SUMMARY

Embodiments according to the invention can provide smart cards, methods, and computer program products for using dummy currents to obscure data. Pursuant to these embodiments, a smart card can include a circuit configured to conduct security operations on data maintained by the smart card and to generate currents indicative of the security operations. A current transforming circuit is coupled to the circuit and is configured to consume amounts of dummy currents based on the security operations. In some embodiments according to the invention, the amounts of dummy currents are based on amounts of currents associated with the security operations.

In some embodiments according to the invention, the circuit is a CPU and/or a cryptographic operation circuit. In some embodiments according to the invention, the current transforming circuit is configured to generate the amounts of dummy currents before and/or after an amount of current consumed by a corresponding the security operations.

In some embodiments according to the invention, the current transforming circuit is a plurality of differently weighted dummy current circuits. In some embodiments according to the invention, the plurality of differently weighted dummy current circuits are separately operated blocks configured to generate a respective current that is different from others of the separately operated blocks. In some embodiments according to the invention, the separately operated blocks include at least one stage being separately controllable to provide respective equal amounts of current for a respective separately operated block.

In some embodiments according to the invention, the smart card also includes a controller circuit coupled to the current transforming circuit and configured to activate/deactivate a plurality of differently weighted dummy current circuits responsive to the security operations. In some embodiments according to the invention, the controller circuit is further configured to activate/deactivate the plurality of differently weighted dummy current circuits based on predetermined values associated with instructions included in the security operations.

In some embodiments according to the invention, the current transforming circuit further includes a reference block applying a constant reference current to the current transforming circuit. In some embodiments according to the invention, the plurality of differently weighted dummy current circuits include 2ⁿ differently weighted dummy current circuits.

In some embodiments according to the invention, a method of operating a smart card includes conducting security operations on data maintained by the smart card and that generate associated currents indicative of the security operations and generating amounts of dummy currents based on the security operations to obscure the security operations and/or the data.

In some embodiments according to the invention, generating amounts of dummy currents includes generating the amounts of dummy currents before an amount of current consumed by a corresponding the security operations. In some embodiments according to the invention, generating amounts of dummy currents includes generating the amounts of dummy currents after an amount of current consumed by a corresponding the security operations.

In some embodiments according to the invention, generating amounts of dummy currents includes generating the amounts of dummy currents before and after an amount of current consumed by a corresponding the security operations. In some embodiments according to the invention, the dummy currents are generated during arithmetic operations.

In some embodiments according to the invention, a method of operating a smart card includes obscuring security operations on data maintained by the smart card by generating amounts of dummy currents unassociated with operations of a CPU in the smart card. In some embodiments according to the invention, the method further includes generating the amounts of dummy currents before an amount of current consumed by a corresponding the security operations. In some embodiments according to the invention, the method further includes generating the amounts of dummy currents after an amount of current consumed by a corresponding the security operations. In some embodiments according to the invention, a computer program product is configured to carry out the methods.

### BRIEF DESCRIPTION OF THE DRAWINGS

FIG. 1 is a block diagram illustrating an internal structure of a smart card in some embodiments according to the present invention.

FIG. 2 is a block diagram illustrating current transforming blocks shown in FIG. 1.

FIG. 3 is a circuit diagram illustrating an internal configuration of the current consuming block shown in FIG. 2;

FIG. 4 shows a current waveform of a smart card during operation.

FIGS. 5A and 5B show exemplary waveforms provided by some embodiments according to the present invention.

### DESCRIPTION OF EMBODIMENTS ACCORDING TO THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout.

It will be understood that although the terms first and second are used herein to describe elements and should not be limited by these terms. These terms are only used to distinguish one element from another. Thus, a first element discussed below could be termed a second element, and a second element may be termed a first element without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as circuits, methods, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including flash memory, hard disks, CD-ROMs, optical storage devices, or magnetic storage devices.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The present invention is described below with reference to block diagram illustrations of circuits, methods, and computer program products according to embodiments of the invention. It is understood that each block of the illustrations, and combinations of blocks in the illustrations can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block or blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

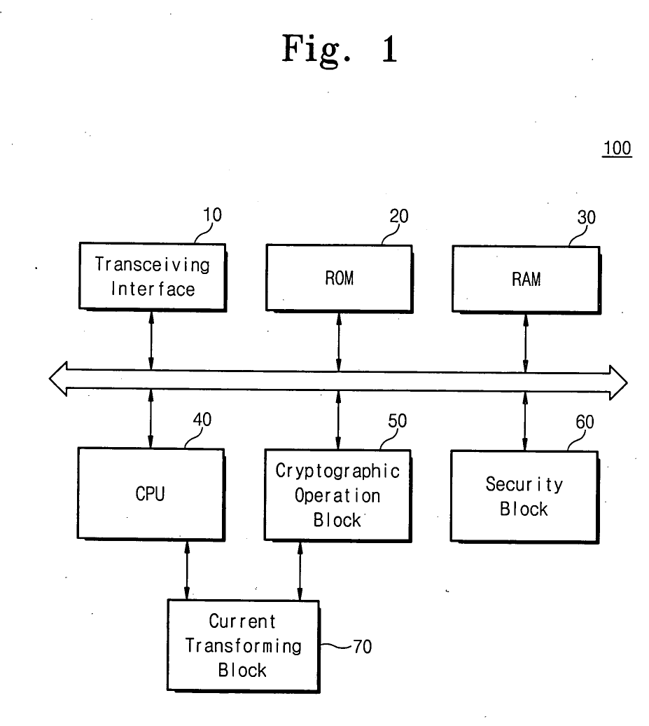

FIG. 1 is a block diagram illustrating embodiments of an internal structure of a smart card in accordance with the present invention. The smart card 100 includes a transceiver interface 10, a read-only memory (ROM) 20, a random-access memory (RAM) 30, a central processing unit (CPU) 40, a cryptographic operation block 50, a security block 60, and a current transforming block 70.

The transceiver interface 10 is provided to transfer data and commands between the smart card 100 and an external device. The ROM 20 is used as a program memory storing a card operating system and basic instructions therein. The RAM 30 stores and manages temporary data and intermediate calculation results, being used as a working register. Although not shown in the drawings, an electrically erasable and programmable ROM may be added thereto as a storage unit to store various data and option programs, and to read, write, and erase data by the card operating system.

The central processing unit 40 functions to control internal paths through which data and command signals are transferred to the components, i.e., the data memory, the program memory, RAM, and so on. The security block 60 can include detectors to sense conditions of current, temperature, frequency, light, or de-capsulation, and may able to reset all circuits, as well as the embedded microprocessor, when at least one of the detectors outputs a detection signal, which may prevent the discovery and/or transfer of otherwise protected information by an external attack, physical destruction, modification, and/or damage due to abnormal operating conditions.

The cryptographic operation block 50 functions to encrypt input data for protection. The protected data can be stored in the encoded form, which may prevent the data from being disclosed (for example via an attack). Such cryptographic methods include a DES (data encryption standard) scheme as a symmetrical cryptography system, and RSA (Rivest, SHamir, and Adelman) as an asymmetrical cryptography system. The DES is a type of secret key cryptography system, that can encrypt a word of 64 bits by combining coded characters with a 64-bit key. RSA is based on the arithmetical difficulty in operating resolution into factors for a very large integer.

As appreciated by the present inventors, a smart card may be attacked by analyzing the pattern of currents dissipated during cryptographic operations, which may indicate the logical values of gates/circuits during the operations. Therefore, the smart card may need to protect the pattern of current dissipation from being disclosed. In some embodiments according to the invention, dummy currents are generated by the current transforming block 70, by which the patterns of current consumed by the circuits in the smart card may be varied to mask the operations of the smart card and thereby allow improved protection from external attacks.

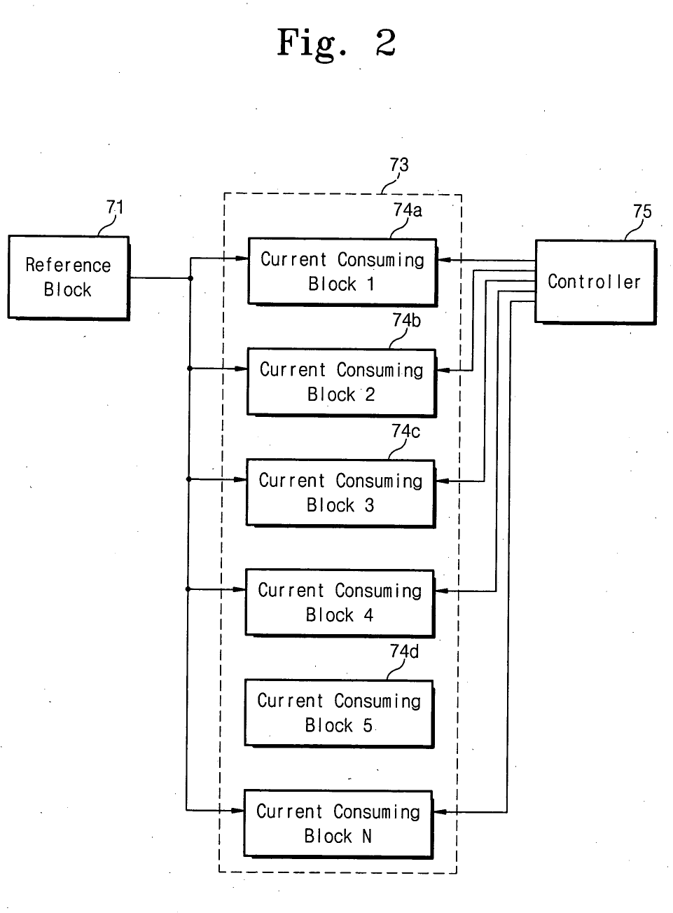

Referring to FIG. 2, the current transforming block 70 includes a reference block 71, current consuming blocks 73, and a controller 75. The controller 75 checks power consumption patterns in the central processing unit 40 and the cryptographic operation block 50, which may provide core arithmetic operations. The controller 75 further controls the current consuming blocks 73 to change the patterns of the current consumed by those operations as observed by an external monitor such as those that may be utilized to conduct SPA and/or DPA attacks. The controller 75 receives the commands (used for operations of the smart card) from the central processing unit 40 and the cryptographic operation block 50 in real time and identifies a type of operation to be conducted in the smart card.

The following Table 1 summarizes the step numbers of the current consuming blocks and the amounts of step currents in an exemplary embodiment according to the invention.

TABLE 1

| Current consuming block | Step number | Step current | |
|---|---|---|---|
| 1 | 1 | 16a | μa |
| 2 | 2 | 8a | μa |
| 3 | 4 | 4a | μa |
| 4 | 8 | 2a | μa |
| 5 | 16 | a | μa |
| 6 | 1 | 16b | μa |
| 7 | 2 | 8b | μa |
| 8 | 4 | 4b | μa |
| 9 | 8 | 2b | μa |
| 10 | 16 | b | μa |

The step number means the number of devices consuming current in the current transforming block. The step current means the amount of current dissipated by each device. In Table 1, the parameters a and b denotes reference current values that may be established in optimal ranges. In some embodiments according to the invention, the step current values are, therefore, dummy current values dissipated (separate from those dissipated through the operations associated with the CPU 10/Cryptographic Operation Block 50) by the devices of the current transforming block.

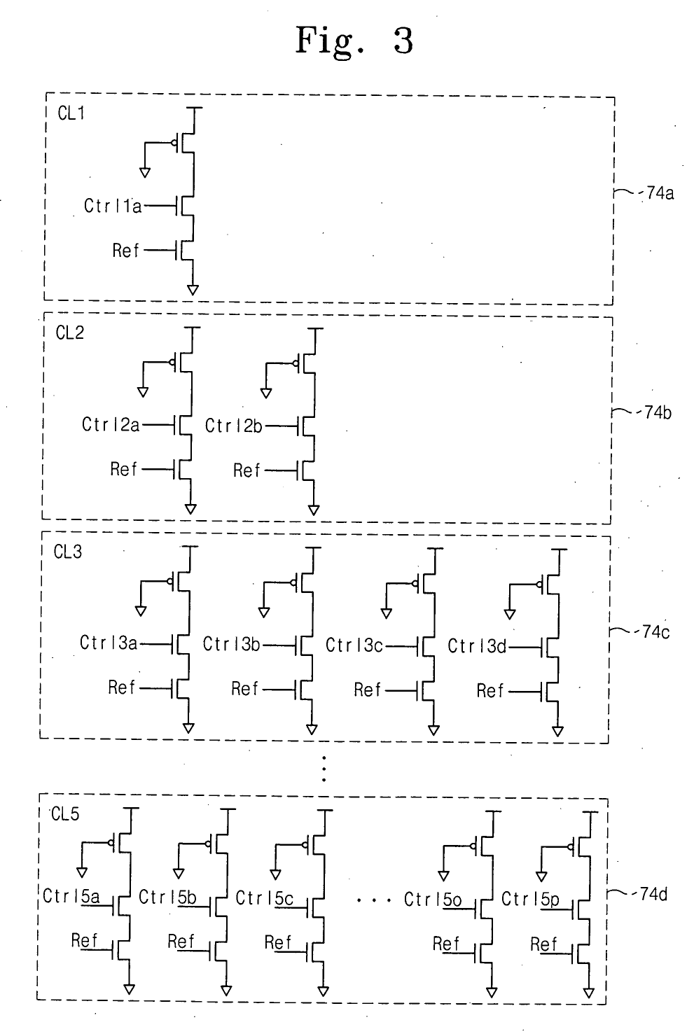

FIG. 3 is a circuit diagram illustrating an internal configuration of the current consuming block shown in FIG. 2 according to some embodiments of the invention. As described on Table 1, the first current consuming block 74a includes a single current consuming device. In some embodiments according to the invention, the current consuming device includes three transistors connected between a power source voltage and a ground voltage in series. The upper transistor is a PMOS transistor whose gate is coupled to the ground voltage. The second transistor is an NMOS transistor whose gate responds to a control voltage provided from the controller. The third transistor is an NMOS transistor whose gate responds to a reference voltage provided from the reference block 71. With such a current consuming device as a unit step (or stage), the second current consuming block 74b can include two steps and the third current consuming block 74c can include four steps. The fifth current consuming block 74d can include sixteen steps. While FIG. 3 illustrates four current consuming blocks 74a˜74d, other current consuming blocks shown in FIG. 2 may be constructed in the same manner illustrated in FIG. 3.

In operations of some embodiments according to the invention, the reference block 71 supplies the same voltage to the current consuming blocks 73, so that the voltage from the reference block 71 may be regarded as an enable signal to activate the current consuming blocks 73 when a power of the smart card is in a turn-on state. According to some embodiments of the controller 75, control voltage to the device of the current consuming block is turned on or off to vary the amount of current dissipation provided by the current consuming blocks 73 and the smart card overall. The controller 75 increases or decreases the current amount in the current consuming block to equalize the amount of current consumption as a whole in correspondence with the pattern of current consumption according to an operation of the smart card. In addition, the controller 75 can generate current peaks between current consuming patterns in correspondence with operational timings or mask the current peaks by increasing current levels before and after the current peaks. In other words, the controller 75 enables the current consuming blocks 73 to generate dummy currents in addition to the current flowing during an operation of the smart card.

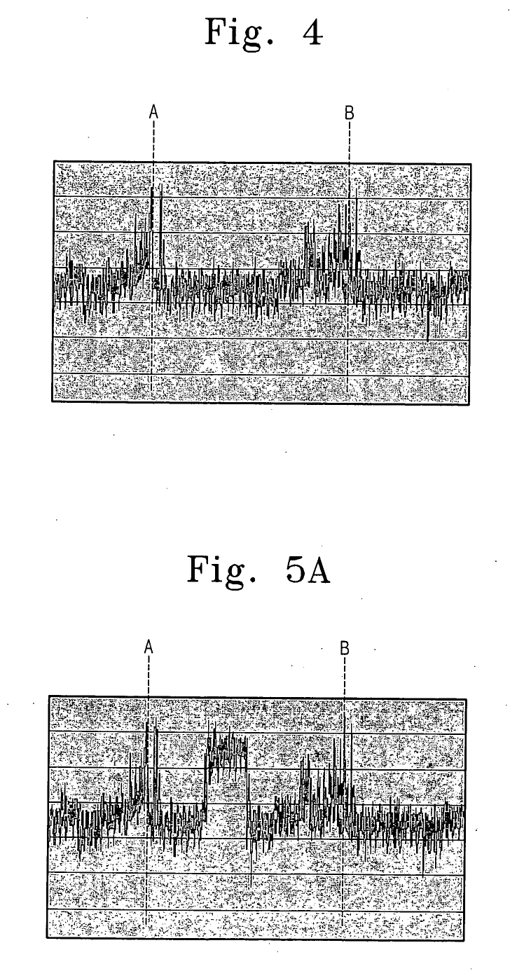

FIG. 4 shows a current waveform of the smart card according to some embodiments of the invention. The parts A and B in FIG. 4 form peak patterns different from other parts of the waveform, which may otherwise provide some information to an external attacker as to the value of a key used by the smart card. The peak patterns may be generated, for instance, during a cryptographic operation by the cryptographic operation block 50 with the central processing unit 40. On the other hand, among arithmetic operations for cryptography, power consuming patterns, which are generated when data relevant to key values of the DES algorithm is being processed, may show minute differences between them in accordance with a value of a data bit to be processed, “0” or “1”. Therefore, the present invention can allow the current consuming patterns to be masked or varied by the current consuming blocks in order to obscure key codes, which may prevent the codes from being discovered by an analysis of the differences in the peak current patterns.

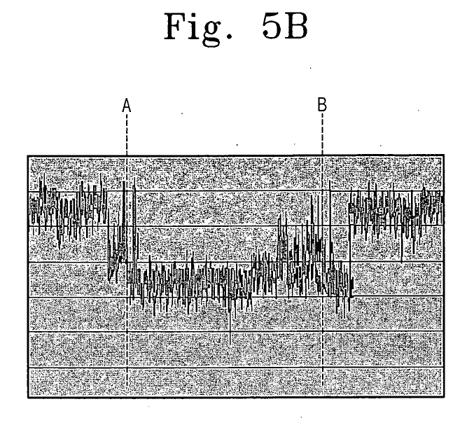

FIGS. 5A and 5B exemplarily show waveforms modified from the current waveform of FIG. 4 using security function according to embodiments of the present invention. FIG. 5A illustrates the case where an additional peak pattern is generated between parts A and B in accordance with an operational timing, while FIG. 5B illustrates the case where the peak patterns are masked by increasing the amount of current consumption as a whole including parts A and B in a block. Other ways for modifying the waveform patterns of current consumption may be available in various features, not limited to those examples.

According to some the embodiments of the invention, dummy currents can be generated before, after, or during operations which may otherwise indicate the operations to an external device so that the externally observable current is altered to mask or obscure the current associated only with operations conducted by the smart card.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

What is claimed:

1. A smart card comprising:
a circuit configured to conduct security operations on data maintained by the smart card and that generates currents indicative of the security operations; and
a current transforming circuit, coupled to the circuit, configured to consume amounts of dummy currents based on the security operations.

2. A smart card according to claim 1 wherein the amounts of dummy currents are based on amounts of currents associated with the security operations.

3. A smart card according to claim 1 wherein the circuit comprises a CPU and/or a cryptographic operation circuit.

4. A smart card according to claim 1 wherein the current transforming circuit is configured to generate the amounts of dummy currents before and/or after an amount of current consumed by corresponding security operations.

5. A smart card according to claim 1 wherein the current transforming circuit comprises a plurality of differently weighted dummy current circuits.

6. A smart card according to claim 5 wherein the plurality of differently weighted dummy current circuits comprise separately operated blocks configured to generate a respective current that is different from others of the separately operated blocks.

7. A smart card according to claim 6 wherein the separately operated blocks comprise at least one stage being separately controllable to provide respective equal amounts of current for a respective separately operated block.

8. A smart card according to claim 1 further comprising:
a controller circuit coupled to the current transforming circuit and configured to activate/deactivate a plurality of differently weighted dummy current circuits responsive to the security operations.

9. A smart card according to claim 8 wherein the controller circuit is further configured to activate/deactivate the plurality of differently weighted dummy current circuits based on predetermined values associated with instructions included in the security operations.

10. A smart card according to claim 1 wherein the current transforming circuit further comprises a reference block applying a constant reference current to the current transforming circuit.

11. A smart card according to claim 8 wherein the plurality of differently weighted dummy current circuits comprise 2ⁿ differently weighted dummy current circuits.

12. A method of controlling a smart card, the method comprising:
conducting security operations on data maintained by the smart card and that generate associated currents indicative of the security operations; and
generating amounts of dummy currents based on the security operations to obscure the security operations and/or the data.

13. A method according to claim 12 wherein generating amounts of dummy currents comprises generating the amounts of dummy currents before an amount of current is consumed by corresponding security operations.

14. A method according to claim 12 wherein generating amounts of dummy currents comprises generating the amounts of dummy currents after an amount of current is consumed by corresponding security operations.

15. A method according to claim 12 wherein generating amounts of dummy currents comprises generating the amounts of dummy currents before and after an amount of current consumed by a corresponding the security operations.

16. A method according to claim 12 wherein the dummy currents are generated during arithmetic operations.

17. A method of controlling a smart card, the method comprising:
obscuring security operations on data maintained by the smart card by generating amounts of dummy currents unassociated with operations of a CPU in the smart card.

18. A method according to claim 17 further comprising:
generating the amounts of dummy currents before an amount of current consumed by corresponding security operations.

19. A method according to claim 17 further comprising:
generating the amounts of dummy currents after an amount of current consumed by corresponding security operations.

20. A computer program product configured to carry out the method according to claim 17.
